(19) United States
(12) Patent Application Publication
(10) Pub. No.: US 2010/0116181 A1
(43) Pub. Date: May 13, 2010

(54) METHOD OF MAKING CELLULOSE/PLASTIC PELLETS HAVING A LOW PLASTIC CONTENT

(76) Inventors: Anton Rudolf Christoffel, Geulle (NL); Ralph Koekkoek, Amsterdam (NL); Alfons Matheas Gertrudes Van Der Linden, Weert (NL); Mohammed Nafid, Maastricht (NL); Löwhardt Adolf Albert Schoen, Spaubeek (NL)

Correspondence Address: NIXON & VANDERHYE, PC, 901 NORTH GLEBE ROAD, 11TH FLOOR, ARLINGTON, VA, 22203, US

(21) Appl. No.: 12/529,976

(22) PCT Filed: Mar. 7, 2007
(86) PCT No.: PCT/EP2007/001951

§ 371 Date: Jan. 26, 2010

(51) Int. Cl. F23K 1/00; F23B 90/00; B29C 47/00; B29B 9/12

(52) U.S. Cl. 110/232; 110/349; 264/299; 428/402

(57) ABSTRACT

Method of making cellulose/plastic pellets in which a particulate cellulose/plastic mixture comprising more than 60 to 95 weight % of cellulosic material and 5 to less than 40 weight % of thermoplastic material, based on the total dry weight of cellulosic and thermoplastic materials, and 1 to 15 weight % of moisture, based on the total weight of the mixture, is supplied at a temperature T₁ of at most 90° C. to a pelletizing device comprising an annular mould with holes having a diameter D of at most 8 mm and an effective hole length L to hole diameter D ratio R of at least 7, the values of R and T₁ being chosen in relation to one another so that the temperature T₂ of the pellets leaving the annular mould is between 80 and 125° C. and the T₂-T₁ rise in temperature is at least 10° C., and cellulose/plastic pellets obtainable by said method.

The present invention relates to a method of making cellulose/plastic pellets comprising more than 60 to 95 weight % of cellulosic material and 5 to less than 40 weight % of thermoplastic material.

Cellulose/plastic waste mixtures originating, for example, from domestic, urban or municipal waste can be processed into useful fuel, preferably secondary fuel for combustion furnaces that is used next to coal as primary fuel. Particulate dried cellulose/plastic waste mixtures can either be combusted as such (as “fluff”), but preferably are converted into a pelletized fuel, e.g. according to the teachings of EP-A-1,083,212 or of U.S. Pat. No. 5,342,418. Such pelletized fuel recyclate has a high heat of combustion and can be handled easily.

Depending on the origin of the waste stream the cellulose/plastic waste mixtures comprise varying amounts of plastic. EP-A-1,083,212 is directed to a method of making pelletized fuel from household and industrial waste streams having a high plastic content of at least 40 weight %. The resulting cellulose/plastic pellets are hard and small, preferably no more than 10 mm in diameter, and can either be combusted directly or be ground prior to combustion. Both forms, the pelletized and the pulverized forms, are particularly suitable as secondary fuel for combustion in furnaces to which the primary fuel and the secondary fuel are supplied separately, the secondary fuel being directly supplied to the flame of the primary fuel.

U.S. Pat. No. 5,342,418 teaches a method of making pelletized fuel from waste streams having a low plastic content of less than 40 weight %, for example waste streams consisting essentially of conventional disposable diapers and hygiene pads. However, the resulting cellulose/plastic pellets considerably differ from those described in EP-A-1,083,212 with respect to their properties as well as their intended use. Although those pellets are also determined as secondary fuel, preferably in addition to coal as primary fuel, they are adapted to be used in admixture with coal and might be handled using standard coal handling equipment. The pelletized fuel forms a uniform fuel mixture with coal and the unground fuel mixture is fed into the combustion chamber of the furnace. The pellets should be consumed in the furnace during approximately the same time period as the coal admixed with them. This usage of the pellets results in particular requirements concerning the properties of the cellulose/plastic pellets, e.g. their dimensions. The cellulose/plastic pellets disclosed in U.S. Pat. No. 5,342,418 are larger than those of EP-A-1,083,212 and have an average diameter of about to 9.4 mm to 16.0 mm. It is described that the pellets are lightly bonded together at the outer surface and readily broken off. Such pellets are neither suitable for being ground to a fine powder nor can they be dosed directly to the flame of a primary fuel.

As modern coal-fired power plants are operated by combusting pulverized coal there is a demand for fuel recyclate as secondary fuel that can be pulverized readily and directly supplied to the flame in the furnace. Hitherto, cellulose-rich cellulose/plastic waste streams having a plastic content of less than 40 weight % could not be converted to useful secondary fuel meeting this demand. This is very disadvantageous because a considerable amount of cellulose-rich polluting waste is presently dumped or processed at high costs while a huge source of energy thus remains untapped.

It is thus an object of the present invention to provide a method of converting cellulose-rich cellulose/plastic waste streams to useful secondary fuel for modern coal-fired power plants where the secondary fuel is ground to a fine powder and directly fed to the flame of the primary fuel.

The object is met by a method of making cellulose/plastic pellets in which a particulate cellulose/plastic mixture comprising more than 60 to 95 weight % of cellulosic material and 5 to less than 40 weight % of thermoplastic material, based on the total dry weight of cellulosic and thermoplastic materials, and 1 to 15 weight % of moisture, based on the total weight of the mixture, is supplied at a temperature T₁ of at most 90° C. to a pelletizing device comprising an annular mould with holes having a diameter D of at most 8 mm and an effective hole length L to hole diameter D ratio R of at least 7, the values of R and T₁ being chosen in relation to one another so that the temperature T₂ of the pellets leaving the annular mould is between 80 and 125° C. and the T₂-T₁ rise in temperature is at least 10° C.

The present invention also relates to cellulose/plastic pellets obtainable by said method as well as to their use as secondary fuel in addition to a primary fuel.

It has surprisingly been found that it is possible to produce pelletized fuel with a low plastic content that is suitable for use as secondary fuel using a pelletizing technique according to the present invention. This is particularly surprising in view of the teachings of EP-A-1,083,212 because the pelletizing method described therein is strictly limited to waste streams comprising at least 40 weight % of plastic and the favourable properties of the pelletized product such as high hardness and good grindability are attributed to the significant amount of plastic is comprised in the pellets.

The particulate cellulose/plastic mixture that is supplied to the pelletizing device comprises more than 60 to 95 weight % of cellulosic material and 5 to less than 40 weight % of thermoplastic material, based on the total dry weight of cellulosic and thermoplastic materials. Preferably, the cellulose/plastic mixture comprises 65 to 90 weight % of cellulosic material and 10 to 35 weight % of thermoplastic material, based on the total dry weight of cellulosic and thermoplastic materials. The cellulose/plastic mixture optionally comprises further materials in minor amounts, e.g. thermosetting polymers and non-combustible impurities, the cellulosic and thermoplastic materials constituting the major components of the particulate mixture. Generally, the cellulosic and thermoplastic materials constitute a total of at least 70 weight % of the mixture, preferably at least 75 weight % of the mixture, more preferably at least 80 weight %, even more preferably at least 85 weight %, and most preferably at least 90 weight %, each based on total solid components. Typically, the cellulose/plastic mixture originates from waste material such as domestic waste (including municipal and urban waste) and/or industrial waste. The cellulosic material may originate from, for example, paper, cardboard, beverage cartons, wood, diapers, bandages, and textiles such as cotton, viscose and rayon. The thermoplastic material may originate from, for example, packing material such as polymeric sheet or film material. In principle, all types of thermoplastic polymers can be present in the waste mixture. Examples of thermoplastic polymers that are generally present in the waste streams to be treated include (substituted) polyolefins; polystyrene; polyesters, such as polyethylenterephthalate (PET); polyamides, and copolymers and blends thereof. The thermoplastic material may also comprise halogenated polymers such as poly(vinyl chloride) (PVC) although this is not preferred. In particular, the thermoplastic material in the cellulose/plastic mixture is mainly based on polyethylene homo- and/or copolymers. Typically, at least 60 weight %, preferably at least 70 weight %, more preferably at least 75 weight %, and most preferably at least 80 weight % of the thermoplastic material are polyethylene homo- and/or copolymers. Typically, the cellulosic material in the cellulose/plastic mixture is mainly based on paper and/or cardboard.

The pelletizing device which is used in the present method comprises an annular mould with holes whose effective hole length (L) and hole diameter (D) ratio (R) is at least 7. The ‘hole diameter’ is in each case understood to be the smallest diameter of the hole which determines the diameter of the pellet. ‘Effective hole length (L)’ is understood to be the length of the part of the hole in which the feed stream is effectively compressed.

Where here and hereinafter reference is made to properties of the pellets or of particles in a collection of particles, this is intended to imply the average value of a sufficiently large number of pellets or particles. “Feed stream” is here and hereinafter each time understood to be the stream of the particulate cellulose/plastic mixture that is fed to the pelletizing device.

In the method according to the invention the feed stream has a temperature (T₁) of at most 90° C., preferably at most 75° C. At this temperature the feed stream has sufficiently good transport properties without involving problems of agglomeration, smearing and filament formation before or in the pelletizing device. ‘Smearing’ is understood to mean that the high temperature causes the plastic to soften, melt or at least become fluid to such an extent that it is smeared over and adheres to all parts with which it comes into contact. In the context of these objectives the temperature is more preferably at most 60° C. and most preferably at most 50° C., depending on the moisture content of the feed stream. At lower moisture contents of the feed stream the temperature may even be lower.

In view of the stability of the pelletizing process and the quality of the pellets obtained, the values of R and T₁ are chosen in relation to one another so that the temperature (T₂) of the pellets leaving the annular mould is between 80 and 125° C. Preferably, temperature T₂ is above 90° C. because then a particularly good pellet hardness is obtained. Preferably, the temperature is lower than 120° C. and even more preferably lower than 115° C. because the pellets leaving the mould will then agglomerate less and need less cooling in the subsequent processing step of pellet cooling. The higher the plastic content, the greater the tendency to agglomerate will be. The rise in temperature (T₂-T₁) that occurs in the pelletizing device is, with a view to obtaining a good hardness, at least 10, more preferably at least 20, even more preferably at least 30 and most preferably at least 40° C. A greater rise in temperature can for example be chosen by setting a higher R. This will result in a more compact and harder pellet. For this reason R is preferably at least 8, more preferably at least 10, even more preferably at least 12 and most preferably at least 15. The value of R that is chosen cannot be any high value as that would adversely affect the productivity. The value of R is therefore generally less than 20. Higher rises in temperature can also be realized by choosing a heated or heat-insulated annular mould.

The diameter of the holes in the annular mould is at most 8 mm. The advantage of this is that harder pellets are then obtained. In view of the desired high hardness the diameter is preferably at most 7, more preferably at most 6, even more preferably at most 5 mm and most preferably at most 4 mm. A possible explanation for this is that the generated heat also penetrates into the interior of the pellet more quickly, resulting in a better adhesion between the softened thermoplastic material and the cellulosic material in the interior of the pellet, too. In view of their production costs, the diameter of the cellulose/plastic pellets is preferably more than 2 mm, more preferably more than 3 mm.

The length of the pellet is generally chosen to be between 0.5 and 10, preferably between 1 and 5, more preferably 1 to 3 times and even more preferably 1 to 2 times the diameter. In view of the pneumatic transport properties, the length is most preferably approximately the same as the diameter. The (average) length can for example be chosen by cutting or breaking the pellets leaving the annular mould with the aid of one or more knives or breaking bars moving relative to the mould surface.

An exemplary pelletizing device that can be used in the present invention is to described in U.S. Pat. No. 5,342,418.

It is understood that the actual processing conditions must be adjusted to the composition of the feed stream, i.e. to the type and amount of polymers constituting the thermoplastic material. In particular, the temperatures are adjusted by an amount that corresponds approximately to the difference in the softening temperature of the thermoplastic materials in the feed stream. It is within the general knowledge of a person skilled in the art to determine the optimum processing conditions.

In the method according to the invention the cellulose/plastic mixture of the feed stream is preferably produced from a waste stream through reduction of its particle size in a reducing device containing a screen mat or rotating drum screen and a grinding device, which screen mat or drum screen, as a result of a frequently varying tensile load working on it, shakes the waste stream loose, during and/or after which it is separated on the basis of size into a fraction of small particles and a fraction of large particles, after which the large particles fraction is reduced to a ground product having the desired particle size in the grinding device and after which the ground product and the small particles fraction are combined. The intensive shaking on the screen mat causes small agglomerated particles to break up, as a result of which a relatively large fraction can already comply with the desired maximum dimensions. This involves a major capacity advantage. Preferably, at least 20 to 30 weight % of the waste stream are already smaller than the mesh size of the screen mat. Another advantage of this method is that heavy parts such as metal parts can be well separated from light particles, such as the particles of cellulosic and thermoplastic materials, as a result of which they can more easily, more completely and more selectively be removed from the waste stream before the large particles fraction is supplied to the grinding device. Preferably, the metal parts are removed by a magnet, preferably a belt magnet, during and/or after the shaking on the screen mat. The capacity will depend on the desired degree of reduction and hence on the difference in particle size between the waste stream and the feed stream. A ‘grinding device’ for this process step is in particular understood to be a shredder, although the method is in principle not limited thereto.

The size of the sieve meshes, and hence of the particles after the grinding, is chosen in relation to the hole diameter of the annular mould. With a view to obtaining a well pelletizable feed stream the size of the particles made of cellulosic and thermoplastic materials in the stream fed to the pelletizing device is preferably predominantly at most 6 times, more preferably at most 5 times and most preferably at most 4 times the hole diameter of the annular mould in the subsequent pelletizing step. ‘Predominantly’ is here understood to imply at least about 75 weight %. If the particles are too large, the residence time of the material in the pelletizing device becomes too long, as a result of which the temperature may become too high and smearing of the plastic particles may occur. It has been found that particularly good pelletizing results can be obtained for pelletized fuel with diameters of between 5 and 8 mm if the particles in the feed stream are predominantly smaller than 30 mm.

As the waste stream usually has a high moisture content, the recycling process of the waste stream usually comprises one or more drying steps. The moisture content plays an important part in pelletizing the feed stream. Moisture contents are expressed in percentages of the total weight, whereas the plastic or cellulose contents are expressed in percentages of the dry weight of the thermoplastic and cellulosic material. The particulate cellulose/plastic mixture used as feed stream in the method according to the invention has a moisture content of 1 to 15 weight % (relative to the total weight of the mixture). Preferably, the moisture content is 1 to 10 weight %, more preferably 2 to 7 weight %. The advantage of a certain minimum amount of water is that the feed stream can be more easily deformed, and hence more easily pelletized. Higher amounts of moisture consume a higher proportion of the heat by evaporation, which heat is needed for softening the thermoplastic material to produce hard pellets. Moisture contents of less than 2 weight % require too long drying times in the preceding drying step(s) and offer no significant advantage for the pelletizing process over moisture contents of from 2 to 7 weight %. The moisture content of the feed stream is also a control parameter for the temperature of the feed stream and the temperature of the pellets leaving the mould. This content is therefore chosen to be such that the temperature of the pellets leaving the mould holes is not higher than 125° C. for reasons and with the specific preferences described above. In the method according to the invention the pellets leaving the annular mould are cooled and dried in a gas stream. The moisture content of the feed stream may on the other hand not be chosen to be so high that the residual moisture content after the production of the fuel pellet is too high because the moisture substantially reduces the calorific value of the fuel pellets on account of the high heat of evaporation. For these reasons the moisture content of the ultimate fuel pellet is preferably less than 5, more preferably even less than 3 weight %.

In a special embodiment of the method according to the invention the pelletizing is carried out in two successive steps, the hole diameter of the annular mould being smaller in the second pelletizing step than in the first pelletizing step. With a view to obtaining a higher total capacity, R is in the first step preferably smaller than in the second step. The advantage of this method is that it is very suitable for producing pellets with very small diameters. The two-step pelletizing process is preferably used for a desired pellet diameter of less than 6 mm, more preferably for a pellet diameter of less than 5 mm and even more preferably for a pellet diameter of less than 4 mm. It is very surprising that such small pellets can be produced with the aid of a pelletizing technique without any risk of too long a residence time and smearing of the plastic particles in the pelletizing step. The aforementioned two-step pelletizing is preferably used if the particle size in the feed stream is greater than about 4, preferably 5, more preferably 6, times the diameter of the ultimate fuel pellet.

The invention also relates to the cellulose/plastic pellets that can be obtained according to the methods described above. The pellets have a high calorific value, good combustion properties and in particular a good hardness, which imparts the pellets good bulk, storage and transport properties, such as in particular good pneumatic dosing properties, little pellet fracture, little dust formation, little particle size segregation, a high density and a good flow behaviour. ‘Pneumatic dosage’ is understood to be the injection of the pellets into the furnace via transport effected with a gas stream (stream of air). Another important desired property is good grindability. The pellets also have a low hygroscopicity, as a result of which the long-term stability may also be better. The absorption of moisture, and hence the ultimate moisture content, will consequently also be less, which is advantageous because moisture reduces the calorific value of the pellets.

All these favourable properties are achieved by the method of the present invention involving a pelletizing technique which is a very cheap forming technique in comparison with other forming technique such as extrusion or agglomeration.

Typically, the cellulose/plastic pellets according to the present invention have a hardness of at least 10 kgf (measured according to the Kahl test). Preferably, the pellets have a hardness of at least 15 kgf. More preferably the hardness is more than 20, even more preferably more than 25 and most preferably more than 30 kgf. The Kahl hardness is determined by using a KAHL pellet hardness tester available form AMANDUS KAHL GmbH & Co. KG, Reinbek, Germany.

The cellulose/plastic pellets according to the present invention have a relatively high heat of combustion. Typically, this will be from 15 to 25 GJ/t and preferably from 20 to 25 GJ/t, depending in part also on the plastic content.

The cellulose/plastic pellets according to the present invention are particularly suitable for use as fuel, in particular as secondary fuel in addition to a primary fuel, for firing furnaces. The invention hence also relates to the use of the cellulose/plastic pellets as secondary fuel in addition to a primary fuel. On account of their good properties, the pellets according to the invention are particularly suitable for combustion in furnaces to which the primary fuel and the secondary fuel are supplied separately, the secondary fuel being supplied to the flame of the primary fuel. This method presents the advantage, for example over the combustion of a mixture of the primary fuel and the secondary fuel, that less solid substance segregation, dust formation and also incomplete combustion take place. The cellulose/plastic pellets according to the present invention may be supplied either in ground or in unground form.

The pelletized fuel is particularly suitable for use in power plant fired with pulverized coal (coal-fired power plants). In such coal-fired power plants pelletized fuel obtained from recycled waste streams has often been used with great problems only. Research has shown that the most of the known pelletized fuel is not suitable for use in power-station furnaces fired with pulverized coal, partly on account of pneumatic dosing problems (poor flow behaviour) and because it is on the one hand too large for direct use and on the other cannot be well ground, which may lead to blockage of the dosing system (injection system) and incomplete combustion and contamination of the bottom ash. It has been found that the cellulose/plastic pellets according to the present invention, especially those with a hardness of more than 10 kgf, are particularly suitable for this application because of their very good grindability. The invention therefore also relates to a method of firing a power plant with pulverized coal as the primary fuel and the cellulose/plastic pellets according to the present invention as secondary fuel wherein the pellets are ground to a fine powder prior to combustion. In view of the grindability, the hardness is preferably at least 15 kgf, more preferably at least 20 kgf. The ground product may either be mixed with the primary fuel, i.e. the pulverized coal, before they are supplied together to the burner or it may be supplied to the burner separately from the coal or it may be directly supplied to the furnace in the boiler. It is preferred to dose the ground product to the furnace separately from the pulverized coal; it is directly supplied to the flames of the primary fuel. Generally, the ground product is supplied directly to the furnace immediately after grinding. The advantages of this are that any transport problems attributable to compacting of the ground product are avoided and that the safety risk of dust explosions occurring is reduced. Preferably, the cellulose/plastic pellets are ground so that at least 80 weight % of the ground product is smaller than 2 mm, more preferably at least 99 weight % of the ground product is smaller than 2 mm and most preferably at least 99 weight % of the ground product is smaller than 1.5 mm. The advantage of this is that combustion will be substantially complete. It has been found that very good grinding results are obtained when an air turbulence mill is used as the grinding device.

The pelletized fuel is also particularly suitable for use in blast-furnaces. Research has also shown that most of the commonly obtainable pelletized fuel is unsuitable for use in blast-furnaces. In blast-furnaces there is a high pressure of about 5 bar (0.5 MPa) and all the transport takes place in closed systems. When a secondary fuel is used the storage and supply of the secondary fuel are under pressure and injection lances are used to supply it. These conditions make it very difficult to use secondary fuel. Blockages were found to occur frequently during transport through the injection systems in the case of both pellets and ground product. In the case of ground product, problems arise in storage, too, as a result of bridge formation. There was therefore a need for an improved method of firing a blast-furnace using a recyclate as a secondary fuel in addition to the primary fuel. It has been found that very good results are obtained when the cellulose/plastic pellets according to the present invention are then supplied directly to the blast-furnace as secondary fuel. Hence, the present invention also relates to the use of the cellulose/plastic pellets as a secondary fuel in a blast furnace. Preferably, the diameter of the pelletized fuel is then less than about 5 mm, more preferably even less than 4 mm, to obtain good flow properties and complete combustion. The use in blast furnaces is favourable because cellulose/plastic pellets have good hardness and cause little dust formation and blockages in the injection system.

Moreover, the cellulose/plastic pellets according to the present invention are also suitable as secondary fuel in lime kilns.

1. A method of making cellulose/plastic pellets in which a particulate cellulose/plastic mixture comprising more than 60 to 95 weight % of cellulosic material and 5 to less than 40 weight % of thermoplastic material, based on the total dry weight of cellulosic and thermoplastic materials, and 1 to 15 weight % of moisture, based on the total weight of the mixture, is supplied at a temperature T₁ of at most 90° C. to a pelletizing device comprising an annular mould with holes having a diameter D of at most 8 mm and an effective hole length L to hole diameter D ratio R of at least 7, the values of R and T₁ being chosen in relation to one another so that the temperature T₂ of the pellets leaving the annular mould is between 80 and 125° C. and the T₂-T₁ rise in temperature is at least 10° C.

2. The method according to claim 1, wherein the particulate cellulose/plastic mixture comprises 1 to 10 weight % of moisture.

3. The method according to claim 1, wherein the thermoplastic material comprises polyethylene homo- and/or copolymers.

4. The method according to claim 1, wherein the holes in the annular mould have a diameter D of at most 6 mm.

5. The method according to claim 1, wherein the pelletizing is carried out in two successive steps, the hole diameter of the annular mould being smaller in the second pelletizing step than in the first pelletizing step.

6. The method according to claim 5, wherein the hole diameter of the annular mould in the second pelletizing step is at most 5 mm.

7. The method according to claim 1, wherein the particulate cellulose/plastic mixture is produced from a waste stream through size reduction thereof in a size reducing device containing a screen mat and a grinding device, said screen mat shaking the waste stream loose as a result of a frequently varying tensile load working on it, during and/or after which it is separated on the basis of size into a fraction of small particles and a fraction of large particles, after which the large particles fraction is reduced to a ground product having the desired particle size in the grinding device, after which the ground product and the small particles fraction are combined.

8. The method according to claim 1, wherein the size of the particles of cellulose/plastic mixture supplied to the pelletizing device is smaller than 6 times the diameter D of the holes in the annular mould of the pelletizing device.

9. Cellulose/plastic pellets obtainable according to the method of claim 1.

10. Use of the cellulose/plastic pellets according to claim 9 as a secondary fuel in addition to a primary fuel.

11. Use according to claim 10 as secondary fuel in a coal-fired power plant, wherein the cellulose/plastic pellets are ground to a fine powder prior to combustion.

12. Use according to claim 10 as a secondary fuel in a blast furnace.

13. Use according to claim 10 as a secondary fuel in a lime kiln.
